(19) United States
(12) Patent Application Publication
(10) Pub. No.: US 2013/0149076 A1
(43) Pub. Date: Jun. 13, 2013

(54) FULLY-INDEPENDENT ROBOT SYSTEMS, APPARATUS, AND METHODS ADAPTED TO TRANSPORT MULTIPLE SUBSTRATES IN ELECTRONIC DEVICE MANUFACTURING

(71) Applicant: APPLIED MATERIALS, INC., Santa Clara, CA (US)

(72) Inventors: Damon Keith Cox, Round Rock, TX (US); Izya Kremerman, Los Gatos, CA (US)

(73) Assignee: APPLIED MATERIALS, INC., Santa Clara, CA (US)

(21) Appl. No.: 13/709,485

(22) Filed: Dec. 10, 2012

Related U.S. Application Data
(60) Provisional application No. 61/569,456, filed on Dec. 12, 2011.

(51) Int. Cl. B65G 49/00; B25J 18/00; B25J 17/02

(52) U.S. Cl. CPC B65G 49/00; B25J 17/02; B25J 18/00; Y10S 901/23; Y10S 901/29
USPC 414/217; 414/800; 414/806; 74/490.06; 74/490.03; 901/23; 901/29

(57) ABSTRACT

Electronic device processing systems and robot apparatus are described. The systems are adapted to efficiently pick or place a substrate at a destination by independently rotating an upper arm, a forearm, a first wrist member, and a second wrist member relative to each other through co-axial drive shafts. Methods of operating the robot apparatus are provided, as are numerous other aspects.

### RELATED APPLICATIONS

The present application claims priority from U.S. Provisional Patent Application Ser. No. 61/569,456, filed Dec. 12, 2011, entitled “FULLY-INDEPENDENT ROBOT SYSTEMS, APPARATUS, AND METHODS ADAPTED TO TRANSPORT MULTIPLE SUBSTRATES IN ELECTRONIC DEVICE MANUFACTURING” (Attorney Docket No. 16851-L/FEG/SYNX/CROCKER S) which is hereby incorporated herein by reference in its entirety for all purposes.

### FIELD

The present invention relates to electronic device manufacturing, and more specifically to systems, apparatus, and methods adapted to transport multiple substrates.

### BACKGROUND

Conventional electronic device manufacturing systems may include multiple chambers, such as process chambers and load lock chambers. Such chambers may be included in cluster tools where a plurality of such chambers may be distributed about a central transfer chamber, for example. These electronic device manufacturing systems may employ transfer robots that may be housed within the transfer chamber to transport substrates between the various chambers. Efficient and precise transport of substrates between the system chambers may be important to system throughput, thereby lowering overall operating and production costs. Furthermore, reduced system size is sought after because distances that the substrates need to move may be reduced. Moreover, material and manufacturing costs may be reduced by reducing system size and complexity.

Accordingly, improved systems, apparatus, and methods for efficient and precise movement of multiple substrates are desired.

### SUMMARY

In a first aspect a robot apparatus is provided. The robot apparatus may be adapted to transport substrates within an electronic device processing system. The robot apparatus includes an upper arm adapted to rotate about a first rotational axis; a forearm coupled to the upper arm at a first position offset from the first rotational axis, the forearm adapted to rotate about a second rotational axis at the first position; first and second wrist members coupled to and adapted for rotation relative to the forearm about a third rotational axis at a second position offset from the second rotational axis, the first and second wrist members each adapted to couple to respective end effectors; and a drive assembly having an upper arm drive assembly having an upper arm drive shaft adapted to cause independent rotation of the upper arm; a forearm drive assembly having a forearm drive shaft adapted to cause independent rotation of the forearm; a first wrist member drive assembly having a first wrist member drive shaft adapted to cause independent rotation of the first wrist member; and a second wrist member drive assembly having a second wrist member drive shaft adapted to cause independent rotation of the second wrist member; and wherein the upper arm drive shaft, forearm drive shaft, first wrist member drive shaft, and second wrist member drive shaft are co-axial.

According to another aspect an electronic device processing system is provided. The electronic device processing system includes a chamber; a robot apparatus at least partially contained in a chamber and adapted to transport a substrate to a process chamber or load lock chamber, the robot apparatus including a base; an upper arm adapted to rotate relative to the base about a stationary first rotational axis; a forearm coupled to the upper arm at a first position offset from the first rotational axis, the forearm adapted to rotate about a second rotational axis at the first position; first and second wrist members coupled to and adapted for rotation relative to the forearm about a third rotational axis at a second position offset from the second rotational axis, the first and second wrist members each adapted to couple to respective end effectors, wherein each respective end effector is adapted to carry a substrate; an upper arm drive assembly having an upper arm drive shaft adapted to rotate the upper arm relative to the base; a forearm drive assembly having a forearm drive shaft adapted to rotate the forearm relative to the upper arm; a first wrist member drive assembly having an first wrist member drive shaft adapted to rotate the first wrist member relative to the forearm; and a second wrist member drive assembly having an second wrist member drive shaft adapted to rotate the second wrist member relative to the forearm; and wherein the upper arm drive shaft, forearm drive shaft, first wrist member drive shaft, and second wrist member drive shaft are co-axial

In another aspect, a method of transporting substrates is provided. The method may be used to transport substrates within an electronic device processing system. The method includes providing a robot apparatus having a base, an upper arm coupled to an upper arm drive shaft, a forearm coupled to a forearm drive shaft, a first wrist member coupled to a first wrist member drive shaft, and a second wrist member coupled to a second wrist member drive shaft wherein all the drive shafts are co-axial; independently rotating the upper arm relative to the base by driving the upper arm drive shaft; independently rotating the forearm relative to the upper arm by driving the forearm drive shaft; independently rotating the first wrist member relative to the forearm by driving the first wrist member drive shaft; and independently rotating the second wrist member relative to the forearm by driving the second wrist member drive shaft

Numerous other features are provided in accordance with these and other aspects of the invention. Other features and aspects of the present invention will become more fully apparent from the following detailed description, the appended claims, and the accompanying drawings.

### BRIEF DESCRIPTION OF THE DRAWINGS

FIG. 1A is a schematic top view of an electronic device processing system including a robot apparatus located in a transfer chamber according to embodiments.

FIG. 1B is a side cross sectional view of a robot apparatus including first and second end effectors (shown fully extended) according to embodiments.

FIG. 2A is a top view of an embodiment of an electronic device processing system having a robot apparatus shown in a transfer chamber in a folded home position.

FIG. 2B is a top view of an embodiment of a robot apparatus shown in a transfer chamber and provided in an orientation retracting a substrate from a process chamber.

FIG. 2C is a top view of an embodiment of a robot apparatus shown in a transfer chamber and provided in an orientation with a substrate fully retracted from a process chamber.

FIG. 2D is a top view of an embodiment of a robot apparatus shown in a transfer chamber and provided in an orientation inserting a replacement substrate into a process chamber.

FIG. 3 is a partial side cross-sectional view of a robot apparatus including vertical motion capability according to embodiments (the upper arm, forearm, first and second wrist members, and first and second end effectors are not shown for clarity).

FIG. 4 is a flowchart depicting a method of operating a robot apparatus according to another embodiment.

### DESCRIPTION

Electronic device manufacturing may require very precise and rapid transport of substrates between various locations. In particular, dual end effectors, sometimes referred to as “dual blades,” may be attached at an end of an arm of a robot apparatus and may be adapted to transport substrates resting upon the end effectors to and from process chambers and/or load lock chambers of an electronic device processing system. When the arms are long, rigidity of the robot mechanism may be a concern in that rapid starts and stops of the robot apparatus may cause vibration of the end effector, which takes time to settle. Furthermore, conventional selective compliance arm robot apparatus (SCARA) type robots may only enter and exit transfer chambers in a straight-on fashion, i.e., along a path radial from their shoulder axis, thereby limiting their versatility.

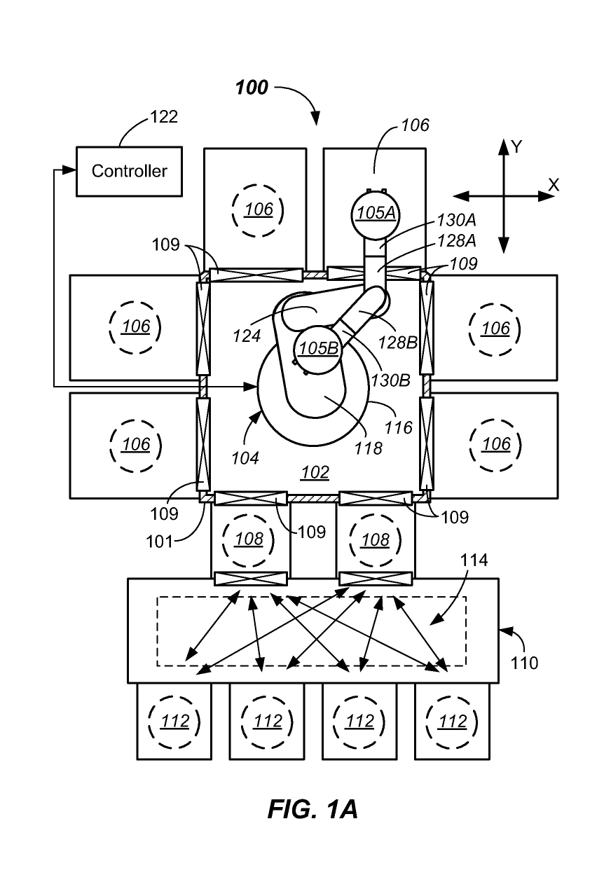

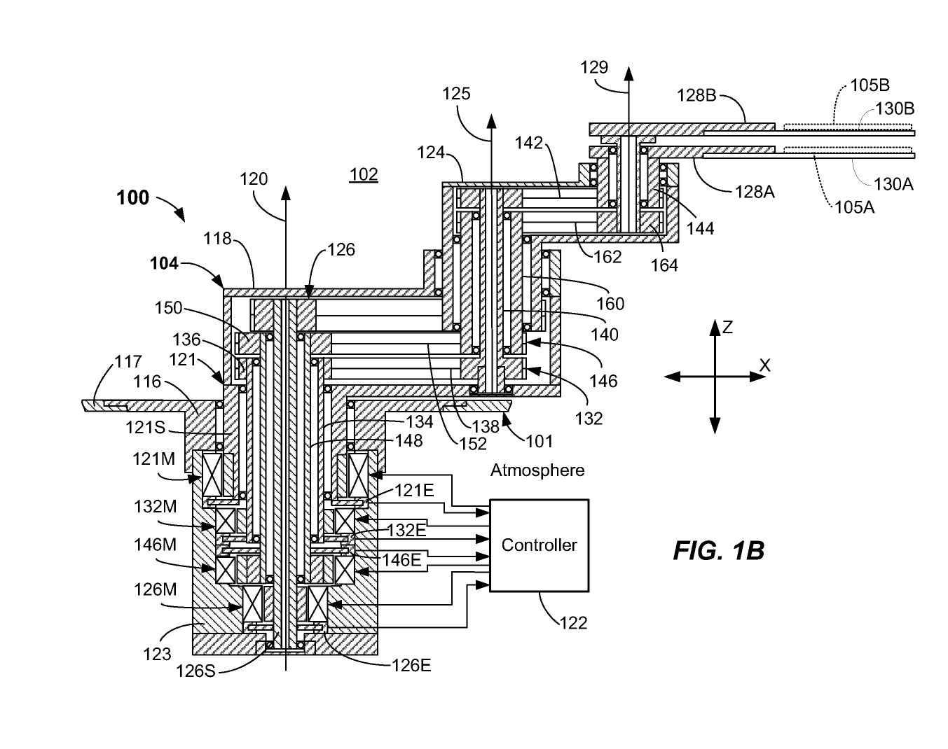

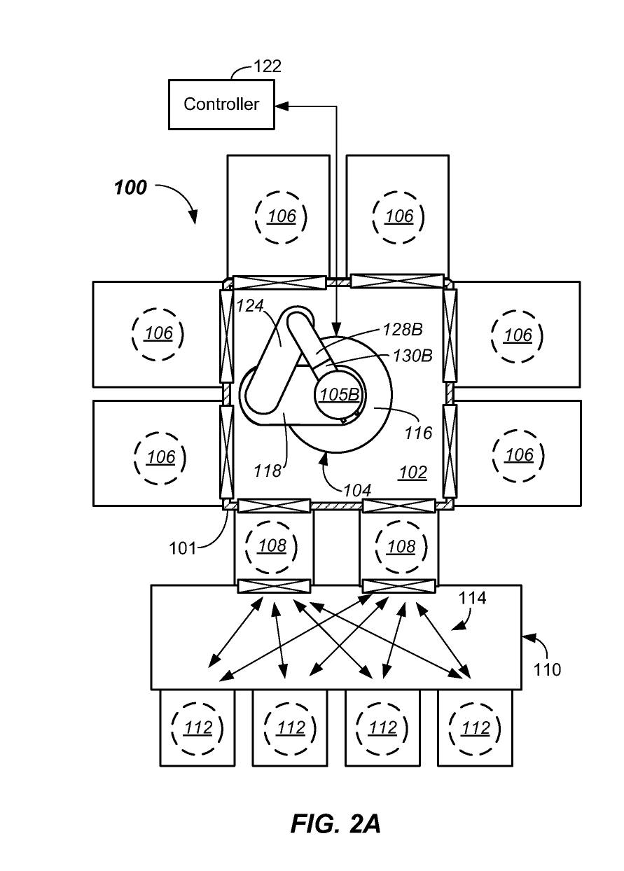

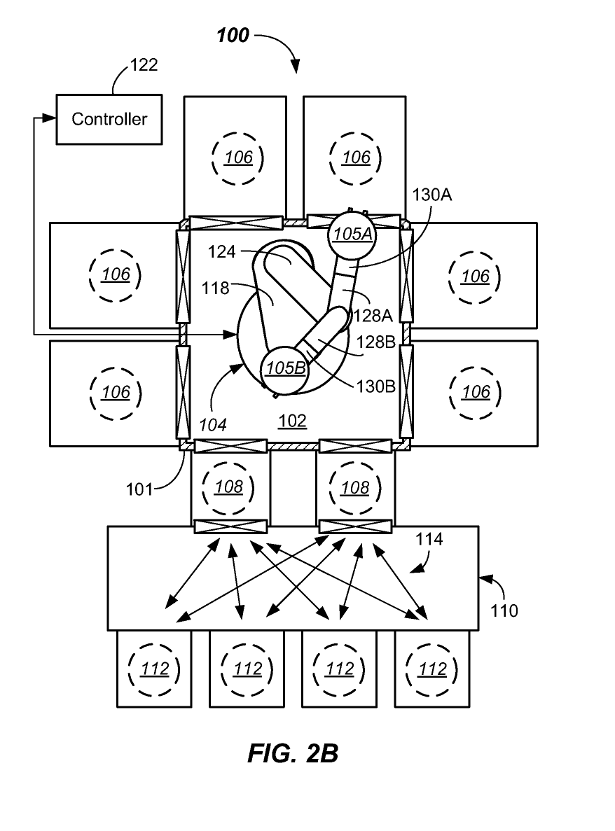

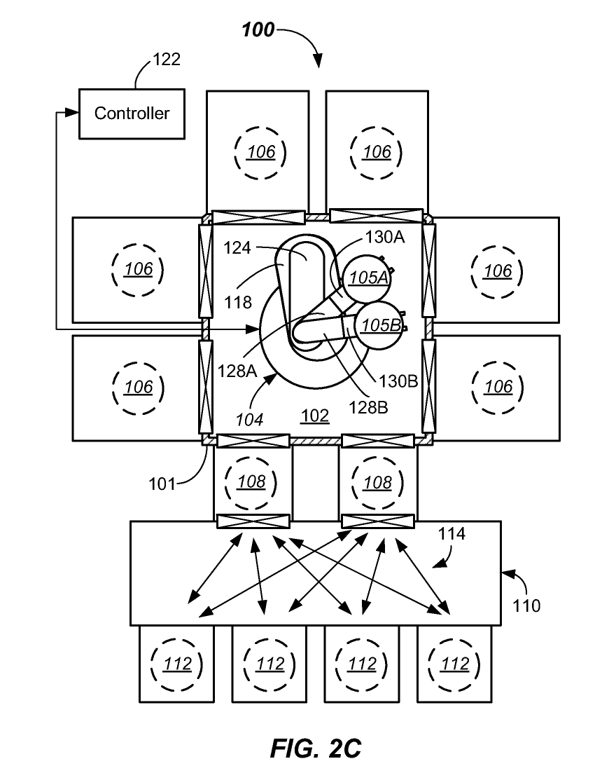

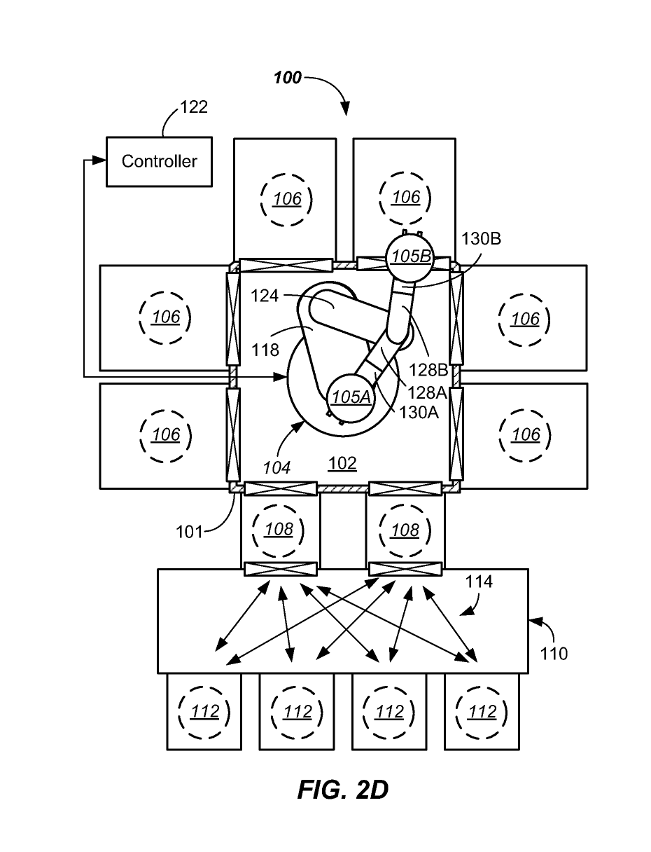

In some systems, especially mainframes having a large number of facets (e.g., 5 or more, 6 or more, or even 8 or more) and multiple load lock chambers, such as shown in FIGS. 1A, and 2A-2D, the transfer chamber is desired to be made as small as possible, in order to reduce system cost and size. Such size reductions may also minimize the distance that substrates need to be moved from process chamber to process chamber and/or between process chambers and load lock chambers. However, packaging the robot apparatus in a small space envelope represents a significant design challenge for existing robots, while still being able to carry out substrate exchange at the various chambers. Further, it is desirable to eliminated motor wires within the vacuum areas, as expensive moving seals (e.g., ferro-fluid seals) may be avoided. Furthermore, abrasion of such wires may be minimized.

In order to reduce the size of the robot and enable servicing of process tools having multiple chambers, and in particular offset chambers, embodiments of the present invention, in a first aspect, provide a robot apparatus having a compact configuration and minimal number of components including dual end effectors, with each robot component being individually controllable. Robot apparatus embodiments include an upper arm, a forearm attached directly to the upper arm, and multiple wrist elements rotatable on the forearm and having attached first and second end effectors. Each of the upper arm, forearm, and multiple wrist elements are independently controllable and moveable. The independent control is provided by including respective drive shafts coupled to the upper arm, forearm, and first and second wrist members that are coaxial. Accordingly, all of the moving components (e.g., upper arm, forearm, and first and second wrist members) may be driven from a common area. The respective drive motors may also be provided in the common area. This highly functional configuration enables the overall size envelope of the robot apparatus to be reduced, and allows entry into process chambers and load locks in a non-straight-on orientation, i.e., non-normal to a chamber facet. Further, this configuration allows offset chambers to be readily serviced. Moreover, the substrate transfer and exchange motions may be carried out with a minimum number of robotic arms and the use of expensive seals may be reduced.

In another aspect, an electronic device processing system is provided that includes a robot apparatus having multiple end effectors that may be used for transporting substrates between chambers in electronic device manufacturing. The electronic device processing system includes a transfer chamber and a robot apparatus at least partially received in the transfer chamber. The robot apparatus includes, as mentioned above, an upper arm rotatable relative to the base, a forearm rotatable on the upper arm, and first and second wrist members rotatable on the forearm. Independent rotational capability of each of the upper arm, forearm, and the first and second wrist members by driving co-axial shafts provides extreme flexibility in the transfer path of substrate carried out during transfer.

Further details of example embodiments illustrating various aspects of the invention are described with reference to FIGS. 1A-4 herein.

Referring now to FIGS. 1A-1B, an example embodiment of an electronic device processing system 100 according to embodiments of the present invention is disclosed. The electronic device processing system 100 is useful, and may be adapted, to transfer substrates between various process chambers, and/or exchange substrates at a load lock chamber, for example. The electronic device processing system 100 includes a housing 101 including a transfer chamber 102. The transfer chamber 102 includes top, bottom, and side walls, and, in some embodiments, may be maintained in a vacuum, for example. A robot apparatus 104 having multiple arms is received in the transfer chamber 102 and is adapted to be operable therein. The robot apparatus 104 may be adapted to pick or place substrates 105A, 105B (sometimes referred to as a “wafer” or “semiconductor wafer”) to or from a destination. However, any type of electronic device substrate or other substrate may be conveyed and transferred by the robot apparatus 105. The destination may be a chamber coupled to the transfer chamber 102. For example, the destination may be one or more process chambers 106 and/or one or more load lock chambers 108 that may be distributed about and coupled to the transfer chamber 102 (FIG. 1A). As shown, transfers may be through a slit valve 109, for example. FIG. 1B illustrates a cross-sectioned side view of the robot apparatus 104 shown in a fully-extended condition for ease of illustration.

Process chambers 106 may be adapted to carry out any number of processes on the substrates 105A, 105B, such as deposition, oxidation, nitration, etching, polishing, cleaning, lithography, metrology, or the like. Other processes may be carried out, as well. The load lock chambers 108 may be adapted to interface with a factory interface 110 or other system component, that may receive substrates from substrate carriers 112 (e.g., Front Opening Unified Pods (FOUPs)) docked at load ports of the factory interface 110. Another robot (shown dotted) may be used to transfer substrates between the substrate carriers 112 and the load locks 108 as indicated by arrows 114. Transfers of substrates may be carried out in any sequence or direction.

Again referring to FIGS. 1A-1B, the robot apparatus 104 may include a base 116 that may include a flange or other attachment features adapted to be attached and secured to a wall 117 (e.g., a floor) of the housing 101 forming a part of the transfer chamber 102. The robot apparatus 104 includes an upper arm 118, which, in the depicted embodiment, is a substantially rigid cantilever beam. The upper arm 118 is adapted to be independently rotated about a first rotational axis 120 relative to the base 116 and/or wall 117 in either a clockwise or counterclockwise rotational direction. Rotation may be +/−360 degrees or more. In the depicted embodiment, the first rotational axis 120 is stationary. By stationary, it is meant that the first rotational axis 120 is immovable in the X and Y directions (FIG. 1A) relative to the base 116. The rotation about first rotational axis 120 may be provided by any suitable motive member, such as by an action of an upper arm drive motor 121M rotating an upper arm drive shaft 121S of an upper arm drive assembly 121. The upper arm drive motor 121M may be a conventional variable reluctance or permanent magnet electric motor. Other types of motors may be used. The rotation of the upper arm 118 may be controlled by suitable commands to the upper arm drive motor 121M from a controller 122. The upper arm drive motor 121M may be contained in a motor housing 123, for example. Any suitable type of feedback device may be provided to determine a precise rotational position of the upper arm 118. For example, a rotary encoder 121E may be coupled between the motor housing 123 and the upper arm drive shaft 121S. The rotary encoder 121E may be magnetic, optical, or the like. In some embodiments, the motor housing 123 and base 116 may be made integral with one another. In other embodiments, the base 116 may be made integral with the wall 117 of the transfer chamber 102.

Mounted and rotationally coupled at a first position spaced from the first rotational axis 118 (e.g., at an outboard end of the upper arm 118), is a forearm 124. The forearm 124 is adapted to be rotated in an X-Y plane relative to the upper arm 118 about a second rotational axis 125 located at the first position. The forearm 124 is independently rotatable in the X-Y plane relative to the upper arm 118 by a forearm drive assembly 126.

The forearm 124 is adapted to be independently rotated in either a clockwise or counterclockwise rotational direction about the second rotational axis 125. Rotation may be +/− about 150 degrees or more. The independent rotation about second rotational axis 125 may be provided by any suitable motive member, such as by an action of a forearm drive motor 126M of the forearm drive assembly 126. The forearm drive motor 126M may be a conventional variable reluctance or permanent magnet electric motor. Other types of motors may be used. The rotation of the forearm 124 may be controlled by suitable commands to the forearm drive motor 126M from the controller 122. Like the upper arm drive motor 121M, the forearm drive motor 126M may be contained in the motor housing 123. Any suitable type of feedback device may be provided to determine a precise rotational position of the forearm 124. For example, a rotary encoder 126E may be coupled between the motor housing 123 and the forearm drive shaft 126S. The rotary encoder 126E may be magnetic, optical, or the like.

Located at a second position spaced (e.g., offset) from the second rotational axis 125 (e.g., on an outboard end of the forearm 124) are multiple wrist members (e.g., first wrist member 128A and second wrist member 128B). The invention will be described with two wrist members. However, it should be apparent that addition independently-rotatable wrist members may be added (e.g., three or more) at the second position. The wrist members 128A, 128B are each adapted for independent rotation in the X-Y plane relative to the forearm 124 at the second position about a third rotational axis 129. Furthermore, the wrist members 128A, 128B are each adapted to couple to end effectors 130A, 130B (sometimes referred to as a “blades”), wherein the end effectors 130A, 130B are each adapted to carry and transport a substrate 105A, 105B during pick and/or place operations.

The end effectors 130A, 130B may be of any suitable construction. The end effectors 130A, 130B may be passive or may include any suitable active means for holding the substrates 105A, 105B such as a mechanical clamping mechanism or electrostatic holding capability. The end effectors 130A, 130B may be coupled to the wrist members 128A, 128B by any suitable means such as mechanical fastening, adhering, clamping, etc. Optionally, the respective wrist members 128A, 128B and end effectors 130A, 130B may be coupled to each other by being formed as one integral piece. Rotation of each wrist member 128A, 128B is imparted by first and second wrist member drive assemblies 132, 146 as will be described herein below.

The first wrist member 128A is adapted to be independently rotated in an X-Y plane relative to the forearm 124 in either a clockwise or counterclockwise rotational direction about the third rotational axis 129 by the first wrist member drive assembly 132. Rotation may be +/− about 150 degrees or more. In the depicted embodiment, action of a first wrist member drive motor 132M causes the rotation. The first wrist member drive motor 132M may be a conventional variable reluctance or permanent magnet electric motor. Other types of motors may be used. The rotation of the first wrist member 128A may be controlled by suitable commands to the first wrist member drive motor 132M from the controller 122. Like the upper arm drive motor 121M, the first wrist member drive motor 132M may be contained in the motor housing 123.

The first wrist member drive assembly 132 in the depicted embodiment includes a first wrist member drive shaft 134 having a rotor of the first wrist member drive motor 132M coupled to the first wrist member drive shaft 134 at one portion (e.g., on a lower end) and a stator stationarily mounted in a motor housing 123, wherein the first wrist member drive motor 132M is adapted to drive a first wrist member driving member 136 coupled to the first wrist member drive shaft 134. The first wrist member driving member 136 may be larger in diameter that the shaft itself (e.g., may be a drive pulley). The first wrist member driving member 136 may be separate from or integral with the first wrist member drive shaft 134.

In the depicted embodiment, a first lower transmission element 138 may be connected between the first wrist member driving member 136 and a first transfer shaft 140. Also, a first upper transmission element 142 is connected between the first transfer shaft 140 and a first wrist member driven member 144. The first transfer shaft 140 may include integral or rigidly-attached pulleys at opposite ends that interface with the transmission elements 138, 142. The transmission elements 138, 142 may be belts, straps, or the like. Preferably, the transmission elements 138, 142 are thin metal straps pinned at their respective ends to the respective driving 136 and driven members 144 and to the pulleys of the first transfer shaft 140.

The second wrist member 128B is also adapted to be independently rotated in an X-Y plane relative to the forearm 124 in either a clockwise or counterclockwise rotational direction about the third rotational axis 129. The motion of the second wrist member 128B is caused by a second wrist member drive assembly 146. Rotation of the second wrist member 128B about the third rotational axis 129 may be +/− about 150 degrees or more. In the depicted embodiment, action of a second wrist member drive motor 146M causes the rotation, and may be a conventional variable reluctance or permanent magnet electric motor. Other types of motors may be used. The rotation of the second wrist member 128B may be controlled by suitable commands to the second wrist member drive motor 146M from the controller 122. Like the first wrist member drive motor 132M, the second wrist member drive motor 146M may be contained in the motor housing 123.

The second wrist member drive assembly 146 in the depicted embodiment includes a second wrist member drive shaft 148 having a rotor of the second wrist member drive motor 146M coupled to the second wrist member drive shaft 148 at one portion (e.g., on a lower end) and a stator stationarily mounted in a motor housing 123, wherein the second wrist member drive motor 146M is adapted to drive a second wrist member driving member 150 coupled to the second wrist member drive shaft 148. The coupling may be by a mechanical connection (e.g., a pin or set screw) or via making the driving member 150 integral with the second wrist member drive shaft 148. The second wrist member driving member 150 may be larger or smaller in diameter than the shaft 148 (e.g., may be a drive pulley).

In the depicted embodiment, a second lower transmission element 152 is connected between the second wrist member driving member 150 and a second transfer shaft 160. Also, a second upper transmission element 162 is connected between the second transfer shaft 160 and a second wrist member driven member 164. The second transfer shaft 160 may include integral or rigidly-attached pulleys at opposite ends that interface with the transmission elements 152, 162. The transmission elements 152, 162 may be belts, straps, or the like. Preferably, the transmission elements 152, 162 are thin metal straps pinned at their respective ends to the respective second wrist driving member 150 and second wrist driven member 164 and to the pulleys of the second transfer shaft 160.

Any suitable type of feedback devices may be provided to determine precise rotational position of the first and second wrist members 128A, 128B. For example, rotary encoders 132E, 146E may be coupled between the motor housing 123 and the respective first and second drive shafts 134, 148. The rotary encoders 132E, 146E may be magnetic, optical, or any other suitable type of encoder.

Again referring to FIGS. 1A and 1B, in operation, in order to move the end effector 130A to a desired destination for a pick of a substrate 105A, the upper arm 118 and forearm 124 may be independently rotated a sufficient amount, along with the first wrist member 128A, to pick a substrate 105A from a chamber (e.g., a process chamber 106). At the same time, the second wrist member 128B is independently rotatable in the X-Y plane relative to the forearm 124, such that the substrate 105B to be exchanged (placed) at the desired destination (process chamber 106) may be positioned and ready so that when the substrate 105A is retracted from the process chamber 106 and first wrist member 128A is rotated to a holding location in the transfer chamber 102, the second wrist member 128B may be rotated into place and inserted into the process chamber 106 to place the substrate 105B at the desired destination location (e.g., onto lift pins or a pedestal). As is depicted in FIG. 1A, offset process chambers 106 may be readily serviced by the robot apparatus 104. In particular, when a direct line of entry into the chambers 106 (perpendicular to a facet of the chamber) is offset from the shoulder axis (first axis 120) the independent rotational capability and limited number of components of the robot apparatus 104 allows such offset entry along a line that is not coincident with the first axis 120.

In the depicted embodiment of FIG. 1A, the robot apparatus 104 is shown located and housed in a transfer chamber 102. However, it should be recognized that this embodiment of robot apparatus 104, may advantageously be used in other areas of electronic device manufacturing, such as within a factory interface 110 wherein the robot apparatus 104 may operate to transport substrates between substrate carriers 112 (e.g., FOUPs—Front Opening Unified Pods) mounted to load ports and one or more load lock chambers 108 of the electronic device processing system 100, for example. The robot apparatus 104 described herein is also capable of other transporting uses.

FIGS. 2A-2D illustrate various positional capabilities of the embodiments of the robotic apparatus 104 within the electronic device processing system 100. In each, as will be apparent from the following description, the upper arm 118 may be independently rotated relative to the base 116. Similarly, the forearm 124 may be independently rotated relative to the upper arm 118. Likewise, the first and second wrist members 128A, 128B (and coupled first and second end effectors 130A, 130B) may be independently rotated relative to the forearm 124, and also relative to each other. Thus, the robot apparatus 104 exhibits extreme versatility to accomplish any desired trajectory when transferring substrates (e.g., substrates 105A, 105B).

For example, FIG. 2A illustrates the robot apparatus 104 provided in the housing 101 with the upper arm 118, forearm 124, and wrist members 128A, 128B all rotated such that they lie in a triangular orientation. Because the center of the substrates 105A, 105B are oriented approximately at the location of the first rotational axis 120, this allows the robot apparatus 104 to be quickly rotated to reposition the robot apparatus 104 to service any of the process chambers 106 or load lock chambers 108 without imparting substantial centrifugal force to the substrates 105A, 105B. In the depicted embodiment, eight chambers 106, 108 are shown. However, it should be understood that the robot apparatus 104 may service more or less numbers of chambers.

FIG. 2B illustrates the electronic device processing system 100 including the robot apparatus 104 with the wrist element 128B and end effector 130B being retracted from chamber 106 after picking up a substrate 105A. The upper arm 118, forearm 124, and wrist element 128A may be rotated independently as the end effector 130A is retracted from the process chamber 106. At the same time, the wrist element 128B and end effector 130B containing another substrate 105B are rotated and positioned and readied to be inserted into the same process chamber 106 when the substrate 105A is removed therefrom. Because the two wrist members 128A, 128B are independently rotatable relative to one another, the substrate awaiting insertion (e.g., substrate 105B) can always be placed at a convenient, non-interfering position within the transfer chamber 102 as the substrate 105A is being retracted. Similarly, once withdrawn, the substrate 105A can always be placed at a convenient, non-interfering position within the transfer chamber 102 as the substrate 105B is being placed into the process chamber 106.

FIG. 2C illustrates another possible intermediate orientation that may be utilized when quickly moving the robot apparatus 104 to retract the end effector 128A and insert the end effector 128B. In the depicted embodiment, as soon as the substrate 105A mounted on the end effector 130A is extracted from the process chamber 106, the substrate 105B mounted on end effector 103B may be rotated and inserted into the process chamber 106 just vacated by end effector 130A. Thus, it should be apparent that not only can the end effectors 130A, 130B be inserted into the chamber 106 in a non-straight-on fashion (i.e., non-perpendicular to a facet of the process chamber 106) and service offset chambers 106, but the independent rotation capability of the end effectors 130A, 130B allows the other substrate 105B to be positioned very close to the facet so that the pick and place operation may take place rapidly. In this orientation, made possible by the small number of arms, and the independent rotation capability of the upper arm 118, forearm 124, and first and second wrist members 128A, 128B, rapid pick and place operations may take place at a destination.

FIG. 2D illustrates another possible intermediate orientation that may be utilized while rapidly moving the robot apparatus 104 to insert the end effector 130B into the process chamber 106 just vacated by end effector 130A. In the depicted embodiment, the upper arm 118, forearm 124, and substrate 105A mounted on the end effector 130A are rotated out of the way and into a non-interfering position in the transfer chamber 102, and the end effector 130B is rotated into place and inserted into the process chamber 106. The process chamber 106 is offset from the first axis 120, but initial entry may also be non-straight through the facet, thus allowing the overall size of the mainframe housing 101 to be reduced.

As should be apparent, because each of the drive motors 121M, 126M, 132M, and 146M (FIG. 1B) in the depicted embodiment are consolidated and contained within the motor housing 123, they may be electrically coupled directly through one or more simple, sealed electrical connections through the motor housing 123. Accordingly, conventional slip ring assemblies for feeding power into the drive motors are not required. Furthermore, because the upper arm 118, forearm 124, and first and second wrist members 128A, 128B are all driven remotely by co-axial drive shafts 121S, 126S, 134, and 148, and the drive motors 121M, 126M, 132M, 146M are collocated in the motor housing 123, the coupled wiring need not pass into the various upper arm, forearm, etc. as in some prior robots. Accordingly, a simpler construction is provided. Furthermore, the use of a hermetic seal (e.g., a ferrofluid seal) may be avoided as all the drive motors 121M, 126M, 132M, and 146M are provided at vacuum within the motor housing 123. Thus, the robot apparatus 104 is devoid of a ferrofluid seal.

The drive shafts 121S, 126S, 134, and 148, first and second transfer shafts 140, 160, and first and second wrist members 128A, 128B may be supported by suitable low-friction, rotation-accommodating bearings or bushings. For example, ball bearings may be used.

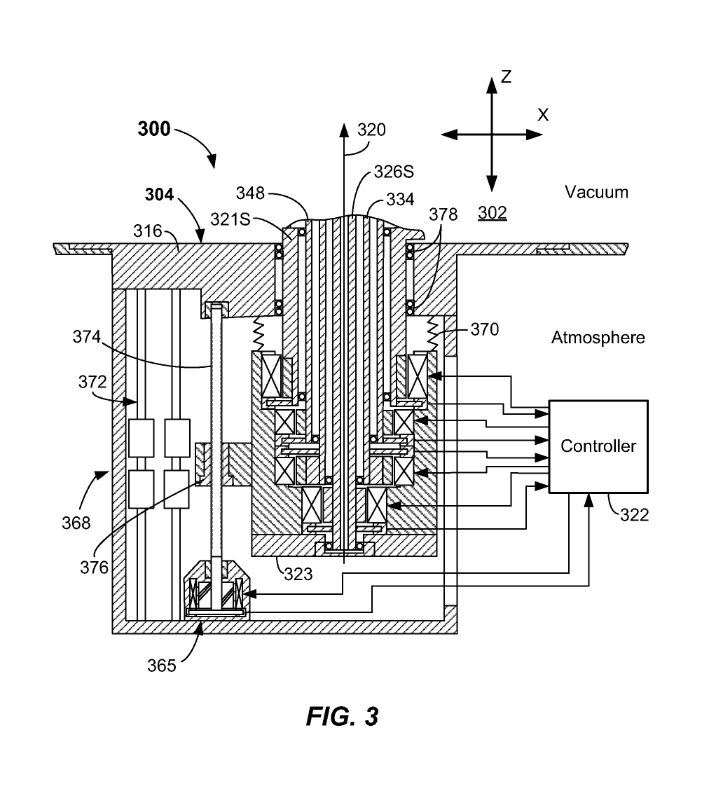

In FIG. 3, a transportation system 300 having a robot apparatus 304 is shown that optionally may further include a vertical motor 365 and a vertical drive mechanism 368. The respective drive shafts 321S, 326S, 334, and 348 have been elongated slightly from the previous embodiment to accommodate the vertical axis motion. The upper arm, forearm, first and second wrist members, and end effectors are identical to that previously-described embodiment and are not shown in FIG. 3 for clarity. The base 316 is modified and enlarged to accommodate the components enabling the Z-axis capability. The vertical motor 365 and a vertical drive mechanism 368 are adapted to cause vertical motion (along the Z axis) of the upper arm, forearm, first and second wrist members, and connected end effectors (all not shown). The vertical drive mechanism 368 may include a worm drive, lead screw, ball screw, or rack and pinion mechanism that when moved (e.g., rotated) by the vertical motor 365 causes the motor housing 323 to translate vertically along the first rotational axis 320. A bellows 370 or other suitable vacuum barrier may be used to accommodate the vertical motion and also act as a vacuum barrier between the chamber (e.g., transfer 302) and the outside of the motor housing 323 that may be provided at atmospheric pressure. One or more translation-accommodating devices 372, such as linear bearings, bushings, or other linear motion restraining means may be used to restrain the motion of the motor housing 323 to vertical motion only (e.g., Z-axis motion) along the first rotational axis 320. Lateral and rotational motion of the motor housing 323 is retrained by the translation-accommodating devices 372. In the depicted embodiment, a lead screw 374 mounted between the base 316 and the vertical drive motor 365 engages a lead nut 376 mounted to the motor housing 323. Drive signals from the controller 322 to the vertical motor 365 cause the vertical motion of the motor housing 323 relative to the base 316, and thus vertical motion of the upper arm, forearm, wrist members, and end effectors (not shown) along the Z-Axis. One or more vertical motion accommodating bearings 378 may be provided that allow vertical motion of the shaft 321S, but also rotation thereof about the first rotational axis 320. Vertical motor 365 may include a rotational feedback device, such as is described herein above to provide vertical position feedback information to the controller 322. The vertical drive motor 365 may be a conventional variable reluctance or permanent magnet electric motor. Other types of motors may be used.

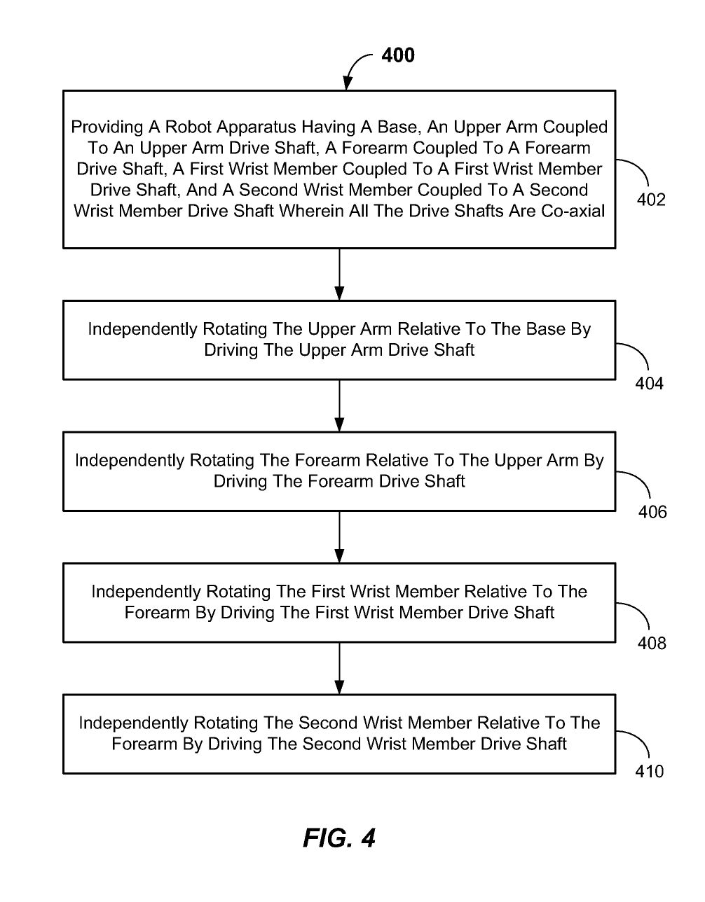

A method 400 of transporting substrates within an electronic device processing system (e.g., electronic processing system 100, 300) according to embodiments of the present invention is provided and described with reference to FIG. 4. The method 400 includes, in 402, providing a robot apparatus (e.g., robot apparatus 104, 304) having a base (e.g., base 116, 316), an upper arm (e.g., upper arm 118) coupled to an upper arm drive shaft (e.g., 121S, 321S), a forearm (e.g., forearm 124) coupled to a forearm drive shaft (e.g., 126S, 326S), a first wrist member (e.g., wrist member 128A) coupled to a first wrist drive shaft (e.g., 134, 334), and a second wrist member (e.g., wrist member 128B) coupled to a second wrist drive shaft (e.g., 148, 348), wherein all the drive shafts are co-axial. For example, in the depicted embodiments, all of the drive shaft axes lie along the first rotational axis (e.g., 120, 320). In 404, the upper arm is independently rotated relative to the base (e.g., base 116, 316) by driving the upper arm drive shaft. In 406, the forearm is independently rotated relative to the upper arm by driving the forearm drive shaft. In 408, the first wrist member is independently rotated relative to the forearm by driving the first wrist member drive shaft. In 410, the second wrist member is independently rotated relative to the forearm by driving the second wrist member drive shaft

As should be apparent, using the robot apparatus (e.g., 104, 304) as described herein, extraction and placement of substrates may be accomplished from or to a destination location. The overall size of the robot apparatus, and thus the chamber (e.g., transfer chamber 102, 302) housing the robot apparatus (e.g., 104, 304) may be reduced. In some embodiments, the method 400 is carried out by simultaneously rotating the upper arm (e.g., upper arm 118), the forearm (e.g., forearm 124), and at least one of the first wrist member (e.g., wrist member 128A) and the second wrist member (e.g., second wrist member 128B) to carry out a pick or place of a substrate from or to a destination, such as a chamber (e.g., a process chamber 106 or load lock chamber 108). In other embodiments, the upper arm (e.g., upper arm 118), the forearm (e.g., forearm 124), the first wrist member (e.g., wrist member 128A), and the second wrist member (e.g., second wrist member 128B) are all simultaneously rotated to carry our transfer of the substrates (e.g., substrate 105A or 105B).

The foregoing description discloses only example embodiments of the invention. Modifications of the above-disclosed systems, apparatus, and methods which fall within the scope of the invention will be readily apparent to those of ordinary skill in the art. Accordingly, while the present invention has been disclosed in connection with example embodiments thereof, it should be understood that other embodiments may fall within the scope of the invention, as defined by the following claims.

The invention claimed is:

1. A robot apparatus, comprising:
an upper arm adapted to rotate about a first rotational axis;
a forearm coupled to the upper arm at a first position offset from the first rotational axis, the forearm adapted to rotate about a second rotational axis at the first position;
first and second wrist members coupled to and adapted for rotation relative to the forearm about a third rotational axis at a second position offset from the second rotational axis, the first and second wrist members each adapted to couple to respective end effectors; and
a drive assembly having
an upper arm drive assembly having an upper arm drive shaft adapted to cause independent rotation of the upper arm;
a forearm drive assembly having a forearm drive shaft adapted to cause independent rotation of the forearm;
a first wrist member drive assembly having a first wrist member drive shaft adapted to cause independent rotation of the first wrist member; and
a second wrist member drive assembly having a second wrist member drive shaft adapted to cause independent rotation of the second wrist member; and
wherein the upper arm drive shaft, forearm drive shaft, first wrist member drive shaft, and second wrist member drive shaft are co-axial.

2. The robot apparatus of claim 1 wherein the upper arm drive assembly includes an upper arm drive motor, a rotor of the upper arm drive motor coupled to the upper arm drive shaft, and a stator of the upper arm drive motor stationarily mounted in a motor housing.

3. The robot apparatus of claim 1 wherein the upper arm is rotatable relative to a base about the first rotational axis, and the first rotational axis is stationary.

4. The robot apparatus of claim 3 wherein the upper arm drive shaft, forearm drive shaft, first wrist member drive shaft, and second wrist member drive shaft are each rotatable about the first rotational axis.

5. The robot apparatus of claim 1 wherein the forearm drive assembly comprises a forearm drive motor adapted to drive the forearm drive shaft, a forearm driving member coupled to the forearm drive shaft, and a transmission member connected between the forearm driving member and a forearm driven member of the forearm.

6. The robot apparatus of claim 5 wherein the forearm drive motor comprises a rotor coupled to the upper arm drive shaft, and a stator stationarily mounted in a motor housing.

7. The robot apparatus of claim 1 wherein the first wrist member drive assembly comprises a first wrist member drive motor adapted to drive the first wrist member drive shaft, a first wrist member driving member coupled to the first wrist member drive shaft, a first lower transmission member connected between the first wrist member driving member and a first transfer shaft, and a first upper transmission member connected between the first transfer shaft and a first wrist member driven member of the first wrist member.

8. The robot apparatus of claim 7 wherein the first wrist member drive motor comprises a rotor coupled to the first wrist member drive shaft, and a stator stationarily mounted in a motor housing.

9. The robot apparatus of claim 1 wherein the second wrist member drive assembly comprises a second wrist member drive motor adapted to drive the second wrist member drive shaft, a second wrist member driving member coupled to the second wrist member drive shaft, a second lower transmission member connected between the second wrist member driving member and a second transfer shaft, and a second upper transmission member connected between the second transfer shaft and a second wrist member driven member of the second wrist member.

10. The robot apparatus of claim 9 wherein the second wrist member drive motor comprises a rotor coupled to the second wrist member drive shaft, and a stator stationarily mounted in a motor housing.

11. An electronic device processing system, comprising:
a chamber;
a robot apparatus at least partially contained in a chamber and adapted to transport a substrate to a process chamber or load lock chamber, the robot apparatus including
a base;
an upper arm adapted to rotate relative to the base about a stationary first rotational axis;
a forearm coupled to the upper arm at a first position offset from the first rotational axis, the forearm adapted to rotate about a second rotational axis at the first position;
first and second wrist members coupled to and adapted for rotation relative to the forearm about a third rotational axis at a second position offset from the second rotational axis, the first and second wrist members each adapted to couple to respective end effectors, wherein each respective end effector is adapted to carry a substrate;
an upper arm drive assembly having an upper arm drive shaft adapted to rotate the upper arm relative to the base;
a forearm drive assembly having a forearm drive shaft adapted to rotate the forearm relative to the upper arm;
a first wrist member drive assembly having an first wrist member drive shaft adapted to rotate the first wrist member relative to the forearm;
a second wrist member drive assembly having an second wrist member drive shaft adapted to rotate the second wrist member relative to the forearm; and
wherein the upper arm drive shaft, forearm drive shaft, first wrist member drive shaft, and second wrist member drive shaft are co-axial.

12. The system of claim 11, wherein each of the upper arm, forearm, first wrist member, and second wrist member are independently rotatable.

13. The system of claim 11, wherein each of the upper arm, forearm, first wrist member, and second wrist member are independently rotatable in an X-Y plane.

14. The system of claim 11, wherein the end effectors are adapted to carry substrates to and from chambers.

15. A method of transporting substrates within an electronic device processing system, comprising:
providing a robot apparatus having a base, an upper arm coupled to an upper arm drive shaft, a forearm coupled to a forearm drive shaft, a first wrist member coupled to a first wrist member drive shaft, and a second wrist member coupled to a second wrist member drive shaft wherein all the drive shafts are co-axial;
independently rotating the upper arm relative to the base by driving the upper arm drive shaft;
independently rotating the forearm relative to the upper arm by driving the forearm drive shaft;
independently rotating the first wrist member relative to the forearm by driving the first wrist member drive shaft; and
independently rotating the second wrist member relative to the forearm by driving the second wrist member drive shaft.

16. The method of claim 15, comprising:
rotating the upper arm about a first rotational axis and in an X-Y plane;
rotating the forearm about a second rotational axis on the upper arm in the X-Y plane;
rotating the first wrist member about a third rotational axis on the forearm in an X-Y plane; and
rotating the second wrist member about a third rotational axis on the forearm in an X-Y plane.

17. The method of claim 15, comprising:
providing an upper arm drive assembly including the upper arm drive shaft adapted to rotate the upper arm relative to the base;
providing a forearm drive assembly including the forearm drive shaft adapted to rotate the forearm relative to the upper arm;
providing a first wrist member drive assembly including the first wrist member drive shaft adapted to rotate the first wrist member relative to the forearm; and
providing a second wrist member drive assembly including the second wrist member drive shaft adapted to rotate the second wrist member relative to the forearm.

18. The method of claim 17, comprising:
providing an upper arm drive motor driving the upper arm drive shaft;
providing an a forearm drive motor driving the forearm drive shaft;
providing an a first wrist member drive motor driving the first wrist member drive shaft; and
providing a second wrist member drive motor driving the second wrist member drive shaft.

19. The method of claim 15, comprising:
providing a first end effector coupled to a first wrist member, and a second end effector coupled to the second wrist member; and
transporting substrates to and from a chamber on the first and second end effectors.

20. The method of claim 15, comprising:
independently rotating the upper arm, the forearm, and the first wrist member, and the second wrist member to carry out a pick of a first substrate and place of a second substrate.
